(19) United States
(12) Patent Application Publication
(10) Pub. No.: US 2005/0093280 A1
(43) Pub. Date: May 5, 2005

(54) Backhoe

(76) Inventor: Adam Jacob, Gilbert, AZ (US)

Correspondence Address: William J. Foley;Cahill, von Hellens & Glazer P.L.C., Ste. 155, 2141 E. Highland Avenue, Phoenix, AZ, 85016, US

(21) Appl. No.: 10/698,790

(22) Filed: Oct. 31, 2003

(51) Int. Cl. B60R 21/02

(52) U.S. Cl. 280/748

(57) ABSTRACT

A transparent guard positioned between the boom swing control of a backhoe and a person standing outside the operator station prevents unintentional manipulation of the control by that person.

### TECHNICAL FIELD

This invention is concerned with improving the operating safety of backhoe earth-working equipment.

### BACKGROUND ART

In most backhoe vehicles swinging, side-to-side movement of the boom is under the control of one or more foot actuated pedals in the proximity of the floor of the operator station. The operator station can be fully enclosed as suggested in the 416C/416CIT Backhoe Loader Catalog ©1999 Caterpillar. However most backhoe vehicles have open operation stations and these pedals are exposed for possible accidental contact by a person standing just outside the operator station and in the swinging path of the boom. Serious injuries and even death have resulted from accidental manipulation of one of the pedals.

### SUMMARY OF THE INVENTION

This invention contemplates providing a guard blocking accidental access to the control pedal or pedals from outside the operator station. Because the guard is in the sight field from the operator station the guard is made from a transparent material, such as a shatter-resistant plastic. The guard preferably is formed of a unitary piece of plastic extending from side-to-side of the operator station, but has a height less than the height of the sight field.

### BRIEF DESCRIPTION OF THE DRAWING

The invention is described in greater detail hereinafter by reference to the accompanying drawings wherein:

FIG. 1 is a side elevational view of a backhoe loader of the type to which this invention applies;

FIG. 2 is a fragmentary plan view of the operator station of the backhoe of FIG. 1;

FIG. 3 is a fragmentary vertical sectional view through the operator station of the backhoe; and

FIG. 4 is a fragmentary perspective view of the operator station from outside the station.

### BEST MODES FOR CARRYING OUT THE INVENTION

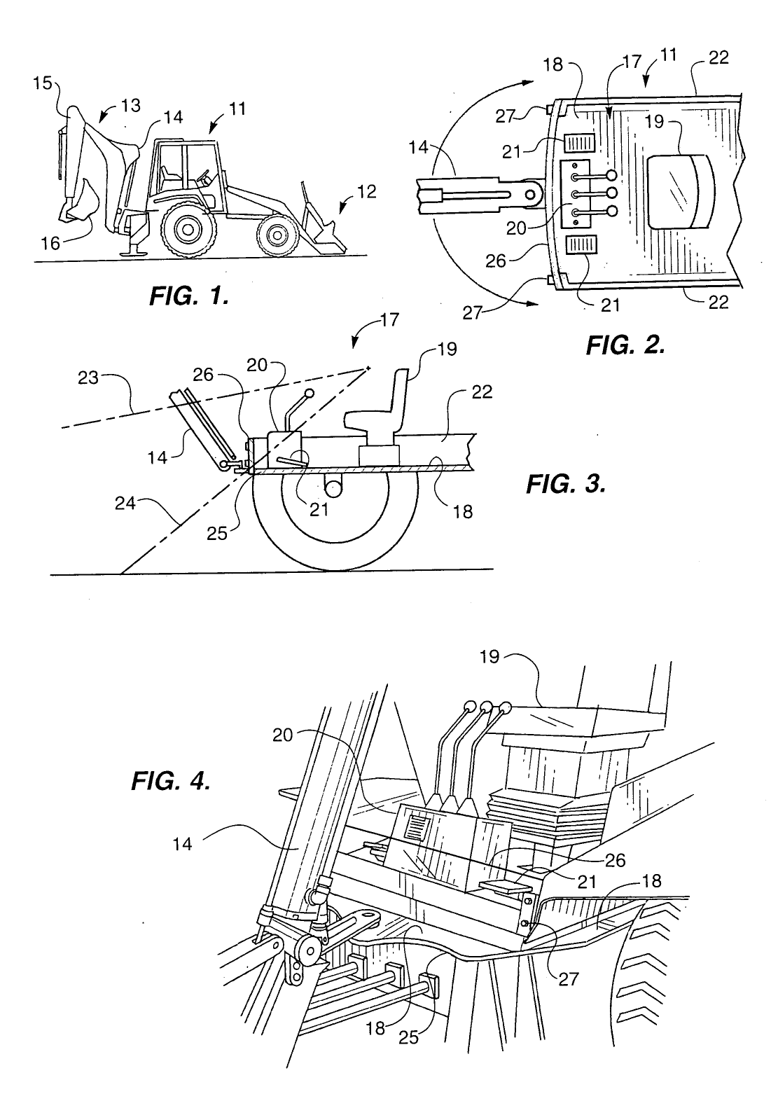

FIG. 1 illustrates a typical backhoe loader comprising a tractor 11, a front loader 12 and a backhoe 13. The backhoe 13 comprises a boom 14, a stick 15 and a bucket 16.

The most common task performed by the backhoe 13 is earth excavation in which the bucket 16 is employed. For other tasks the bucket 16 may be replaced by other tools such as, for example, a hydraulic hammer or a vibratory plate compactor, neither of which is shown. Even with these other tools in place the mechanism is never-the-less referred to as a “backhoe”.

Referring particularly to FIGS. 2 and 3, there is depicted an operator station indicated generally by reference numeral 17. Station 17 is open on all sides and comprises a floor 18, an operator seat 19 and a control console 20. Associated with the control console 20 is one or two foot pedals 21 in proximity to the floor 18 of the operator station. Foot pedals 21 control swinging movement from side-to-side of the backhoe boom 14 (as indicated by the arrows in FIG. 2).

The operator station 17 may have partial side walls indicated at 22.

The sight field of the operator from the operator station 17 is indicated in FIG. 3 by an upper sight line 23 and a lower sight line 24. The sight field next to the lower sight line 24 preferably must remain unobstructed because this is the operator's view of the ground near the tractor 11 where the backhoe 13 operates. The position of sight line 24 is dictated by the rear edge 25 of the floor 18 of the operator station.

A person standing just outside the operator station 17 near the rear edge 25 of the station floor 18 and next to the boom 14 of the backhoe is in a particularly vulnerable position. The boom control pedals 21 are within easy reach of that person and if accidentally manipulated can cause the boom to swing violently causing grave injury to that individual.

To preclude unintentional manipulation of the boom controls 21 a guard 26 is positioned between the outside of the operator station and the pedals 21. This guard is formed of a transparent material so as not to interfere with the operator sight field.

The guard 26 is preferably formed of a single piece of shatter-resistant, acrylic plastic material and extends from side-to-side of the operator station. The guard need have a height of little more than a few inches above the operator station floor 18—less than the height of the sight field at the guards location—and, thus, is light in weight and easily handled for installation. The guard may be held in place by bolts 27 extending through the guard into the side walls 22 of the operator station.

From the foregoing it should be apparent that this invention provides a simple, inexpensive and reliable safety device for a backhoe apparatus.

1. An earth-working backhoe comprising
a) an open operator station having substantially unrestricted sight field to the earth,
b) a boom mounted for swinging movement side-to-side within the sight field from the operator station,
c) an operator-actuated control for the swinging movement of the boom, said control also being near the sight field from the operator station, and
d) a transparent guard blocking accidental access to the control from outside the operator station.

2. The backhoe of claim 1 further characterized in that
a) said operation station has a floor and
b) said control is a foot-actuated control in proximity to the station floor.

3. The backhoe of claim 2 further characterized in that
said guard extends from side-to-side of the operator station.

4. The backhoe of claim 1 further characterized in that
said guard is comprised of a shatter-resistant plastic material.

5. The backhoe of claim 2 further characterized in that
said guard is comprised of a shatter-resistant plastic material.

6. The backhoe of claim 3 further characterized in that
said guard is comprised of a shatter-resistant plastic material.

7. The backhoe of claim 6 further characterized in that
said guard is composed of a unitary sheet of plastic material.

8. The backhoe of claim 3 further characterized in that
said guard has a height less than the height of the sight field from the operator station.
